(19) United States
(12) Patent Application Publication
(10) Pub. No.: US 2010/0104903 A1
(43) Pub. Date: Apr. 29, 2010

(54) Power Plant With Membrane Water Gas Shift Reactor System

(76) Inventors: Mallika Gummalla, Longmeadow, MA (US); Thomas Henry Vanderspurt, Glastonbury, CT (US); Ying She, Worcester, MA (US); Zissis Dardas, Worcerter, MA (US); Benoit Olsommer, South Glastonbury, CT (US)

Correspondence Address: Stephen A. Schneeberger, 49 Arlington Road, West Hartford, CT, 06107, US

(21) Appl. No.: 12/086,937

(22) PCT Filed: Dec. 23, 2005
(86) PCT No.: PCT/US2005/047012

§ 371 Date: Jun. 20, 2008

(51) Int. Cl. H01M 8/18

(52) U.S. Cl. 429/20

(57) ABSTRACT

The fuel processing system of the present invention supplies a flow of H2-rich reformate to a water gas shift membrane reactor, comprising a water gas shift reaction region and a permeate region, separated by an H2-separation membrane H2 formed over a catalyst in the reaction region selectively passes through the H2-separation membrane to the permeate region for delivery to a use point (such as the fuel cell of a fuel cell power plant) A sweep gas, preferably steam, removes the H2 from the permeate region The direction of sweep gas flow relative to the reformate flow is controlled for H2-separation performance and is used to determine the loading of the catalyst in the reaction region Coolant, thermal and/or pressure control subsystems of the fuel cell power plant may be integrated with the fuel processing system

The U.S. Government has a paid-up license in this invention and the right in limited circumstances to require the patent owner to license others on reasonable terms as provided for by the terms of contract No. DE-FC26-05NT42453 awarded by the Department of Energy.

### TECHNICAL FIELD

This invention relates to membrane water gas shift reactors in a fuel processing system, and more particularly to membrane water gas shift reactors included in a fuel processing system for fuel cell power plants and the like.

### BACKGROUND ART

There exists a need to provide hydrogen (H₂) as a fuel for various end uses, particularly as a fuel in fuel cell power plants and the like. The hydrogen is typically chemically bound, as in a raw hydrocarbon and/or including alcohol, or it may be in a processed gas mixture such as syngas (H₂ and CO), which, in either event, is processed by a fuel processing system to provide a hydrogen-rich fuel stream for eventual use as fuel for a fuel cell. The raw fuel is typically reformed by a process that not only provides a hydrogen-rich fuel stream, but which also results in the production of carbon monoxide. Unfortunately, the carbon monoxide is a very effective poison for low temperature fuel cells (<100° C.). The CO gets adsorbed on the noble metal catalyst in the fuel cell stack, thereby preventing the H₂ from reacting. Only a very small concentration of CO is necessary to considerably reduce the number of the reaction sites available. CO concentration of <50 ppm is typically required for a proper operation of the fuel cell stack.

State of the art fuel processing systems rely on the integration of several reactors and heat exchangers (HEXs), e.g., a reformer, a water gas shift reactor train (WGS) and a preferential oxidizer train (PROX) are thermally integrated to produce reformate. This reformate can be fed into the stack after a final CO cleaning is achieved by direct injection of oxygen into reformate. The CO cleaning process (WGSs, PROXs and HEXs) adds weight, volume, complexity and cost to the fuel cell power plant.

Membrane reactors offer an inherent ability to combine reaction, product concentration, and separation in a single unit. A type of membrane reactor of particular interest is an integrated water gas shift reactor with palladium alloy based membrane for selectively removing hydrogen. Broadly speaking, a membrane reactor includes a primary chamber or region containing a catalyst for receiving a hydrogen-rich, gaseous derivative, e.g. reformate, of the raw fuel and reacting the reformate to liberate hydrogen, a secondary chamber or region for receiving nearly pure hydrogen as a permeate from the first region, and a palladium membrane separating the primary and secondary regions and providing a hydrogen-selective permeability for the exclusive transfer of hydrogen from the primary region to the secondary region.

Though membrane reactors have been discussed generally in the literature, as for example in U.S. Pat. No. 6,228,147 to Takahashi for operating a membrane reactor with a steam flow as a sweep gas, relatively little or no discussion exists in the area of the design of the membrane reactor and the integration of such a system into a fuel cell-based power plant. For instance, a recent U.S. Pat. No. 6,572,837 to Holland et al, though discussing a hydrogen-separating membrane in use in a fuel processing system for a fuel cell power plant, describes the hydrogen separation function and structure as being physically separate from the various reactor structures and functions.

An example of a fuel cell power plant that does incorporate a water gas shift reactor integrated with a hydrogen-separating membrane is illustrated and described in U.S. Pat. No. 6,423,435 to Autenrieth, et al. That system tends to work at the relatively high pressure, ie, greater than 10 bar, of 12 bar in the reformer and WGS reactor, and then relies upon a relative vacuum of 0.5 bar to remove the H₂ from the hydrogen collecting space, but then further re-pressurizes that H₂ to about 1.5 bar to feed the anode of the fuel cell. This system also employs some measure of heat and water management to provide limited assistance to the efficiency of the system. While the foregoing examples of fuel processing systems each discuss various ways of separating hydrogen from a reformate stream, at most only limited attention is given to the efficient integration of that process into the overall system of a power plant, particularly in a fuel cell power plant of the type having a PEM (polymer electrolyte membrane) fuel cell assembly that incorporates porous water transport plates and operates at or near, ambient pressure.

It is an objective to provide an arrangement for enhancing the efficiency with which hydrogen is removed from the reformate stream of a fuel processor in the larger context of a power plant. It is a further objective to do so through the use of a membrane water gas shift reactor as part of a fuel processing system in the context of a PEM-type fuel cell power plant. It is a still further objective to do so through the use of a water gas shift reactor as part of a fuel processing system in the context of a PEM-type fuel cell power plant having a fuel cell assembly that incorporates porous water transport plates and operates at moderate pressures near or somewhat above ambient pressure.

### DISCLOSURE OF INVENTION

The present invention pertains to a fuel cell power plant system comprising at least one fuel cell stack assembly including an anode, a cathode, and a coolant channel; a fuel processing system for providing H₂ to the anode and including a water gas shift membrane reactor having a reaction region and a permeate region separated by a H₂ separation membrane, the reaction region being connected to receive a supply of H₂-rich reformate and a supply of water for supporting a water gas shift reaction of the reformate to enhance the production of H₂ and to shift CO to CO₂, the produced H₂ being selectively separated from the reformate stream via the membrane to form a permeate in the permeate region of the reactor, and the reformate stream issuing from the reactor as a retentate; a source of heat; and a water management system operatively connected to the fuel cell assembly coolant channel for conducting water from and to the fuel cell assembly. A stream of sweep gas is caused to flow through the permeate region of the water gas shift membrane reactor to facilitate the separation of H₂ via the membrane. The water management system is additionally connected to the source of heat for converting some water to steam, and the steam may be operatively connected to the permeate region of the water gas shift membrane reactor to provide some or all of the sweep gas flowing there through. In one embodiment, steam is the only sweep gas. In another embodiment, steam is combined with an inert gas, such as nitrogen (N₂) from combusted or otherwise O₂-depleted air.

This integration of the power plant components and functions yields a particularly efficient arrangement, from the standpoint of overall plant efficiency, for generating H₂ for use by the fuel cell of the power plant.

The fuel cell stack assembly is of the PEM type (polymer electrolyte membrane) that incorporates porous water transfer plates (WTPs) for the efficient recovery of water from the fuel cell stack assembly, which water is then available for use in the processing of fuel into H₂, and for the generation of the steam for use as a sweep gas. The system also employs energy recovery devices (ERDs) that serve to recover water from hot exhaust streams while exchanging heat to incoming air. Additionally, selective use of existing thermal energy sources, such as the combustion of the retentate from the fuel processing system for steam generation, enhances the efficiency of the system.

In yet a further aspect of the invention, the sweep gas stream is preferably caused to flow through the permeate region of the water gas shift membrane reactor in a direction that is counter-current (contra) to the flow of the reformate/retentate stream to increase the efficiency for a given volume of the membrane reactor.

In a still further aspect of the invention, a connected combination of a compressor and an expander may be included respectively before and after at least the membrane reactor to efficiently provide limited pressurization of fluid flow through the membrane reactor. That pressurization is moderate, typically being in the range of 1 to 10 bars, and is preferably about 6 to 7 bars.

In yet a further aspect of the invention, the reaction region of the water gas shift membrane reactor contains catalyst loaded or arranged therein to yield an improved efficiency/cost ratio. Particularly, assuming that the sweep gas flows in a direction counter to the flow of the reformate/retentate stream, it is beneficial to use catalyst at or near the opposite ends of the reaction chamber, but to omit its use in the mid-region of the reaction chamber where it is relatively ineffective. In the event the sweep gas flows in a direction concurrent (cocurrent) with the flow of the reformate/retentate stream, it is beneficial to use a limited amount of catalyst only in the entry end or region of the reaction chamber, but to omit its use from the mid-point to the end of the reaction chamber where it is relatively ineffective.

The foregoing features and advantages of the present invention will become more apparent in light of the following detailed description of exemplary embodiments thereof as illustrated in the accompanying drawings.

### BRIEF DESCRIPTION OF DRAWINGS

FIG. 1 is a schematic flow diagram of a fuel cell power plant system employing a water gas shift membrane reactor in accordance with the invention;

FIG. 2 is a perspective functional schematic illustration of a water gas shift membrane reactor, including an expanded longitudinal sectional view of a portion thereof, in accordance with the invention;

FIG. 3 is a schematic flow diagram of part of an alternate embodiment of a fuel cell power plant system employing a water gas shift membrane reactor, depicting a sweep gas for H₂ that flows co-currently with the reformate/retentate flow; and

FIG. 4 is a schematic flow diagram of part of an alternate embodiment of a fuel cell power plant system employing a water gas shift membrane reactor, depicting the use of N₂ as a sweep gas

### BEST MODE FOR CARRYING OUT THE INVENTION

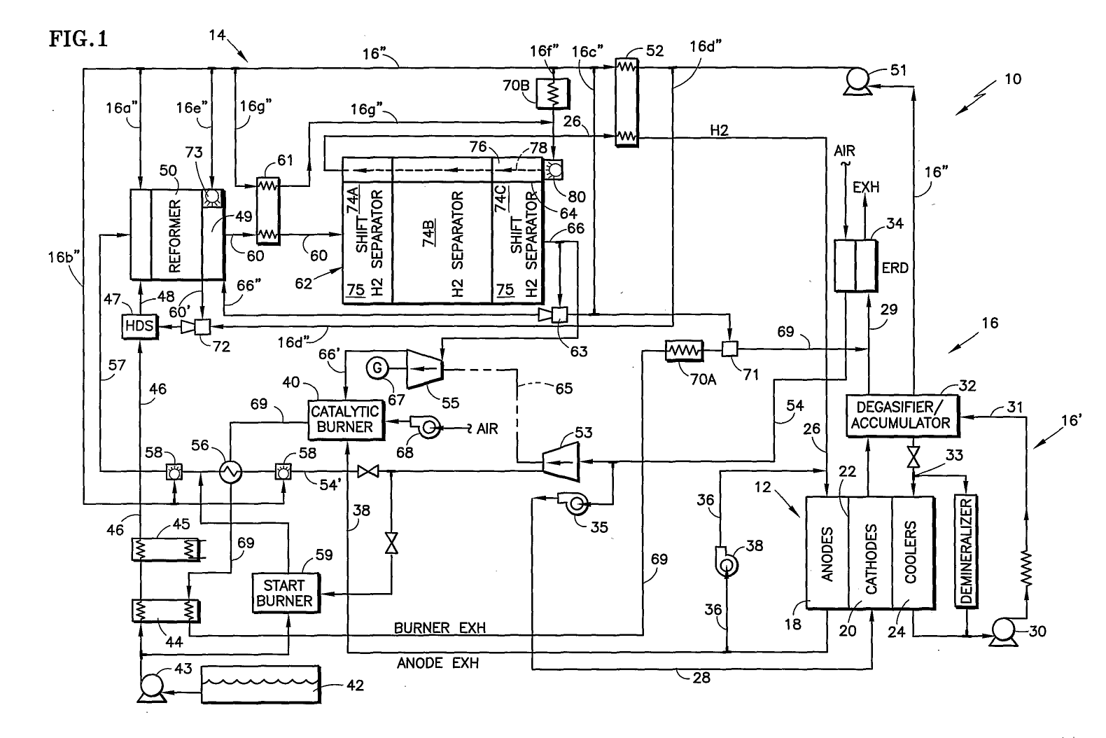

Referring to FIG. 1, a fuel cell power plant 10 in accordance with a preferred embodiment of the invention is depicted, and includes a fuel cell assembly 12 of one or more fuel cells, a fuel processing system generally designated 14, and a coolant system generally designated 16. The fuel cell assembly 12 is preferably of the polymer electrolyte membrane (PEM) type and includes anodes 18, cathodes 20, separating electrolyte membranes 22 and coolers 24 preferably formed of porous water transfer plates (not separately shown) of a type described in U.S. Pat. No. 5,700,595 to Reiser and incorporated herein by reference. A hydrogen-rich (H₂) fuel, or permeate, stream 26 from the fuel processing system (FPS) 14 is supplied to the anodes 18; a supply of oxidant, such as air, is supplied via line 28 to the cathodes 20; and coolant in the form of water (H₂O) circulates in the coolant system 16, and particularly coolers 24, principally as a product of the electrochemical reaction in the fuel cell assembly 12 and any additional make-up water that may be required. The coolant water is additionally used for thermal transfer and/or as a constituent of the reformation and/or WGS processes and/or as a sweep gas in the FPS 14, as will be described.

In a coolant loop 16′ that is local to the fuel cell assembly 12, water exiting from coolers 24 is circulated by pump 30 through circuit 31 to a conventional degasifier/accumulator 32 where gas is removed from the coolant and the water is then accumulated and available in liquid form for return to the fuel cell assembly coolers 24 via line 33. Water accumulated in degasifier/accumulator 32 is also available for use in the FPS 14 via line 16″.

The oxidant supplied to the cathodes 20 via line 28 preferably comprises the passage of ambient air through a gas channel of a water transfer energy recovery device (ERD) 34 of suitable known design, as for example of the type described in U.S. Pat. No. 6,274,259 to Grasso et al and incorporated herein by reference. The driver for that air flow may be, for example, a blower 35. Spent oxidant laden with moisture is exhausted from the cathodes 20 via the degasifier/accumulator 32 and thence on line 29 through the ERD 34, where it transfers heat and moisture to the incoming air.

A stream of spent H₂ is exhausted from the anodes 18 and is both recycled via line 36 by blower 37 to the inlet of the anodes and is also conveyed via line 38 to a catalytic burner 40.

Having described the relatively conventional structure and operation of the PEM fuel cell assembly 12, attention is turned to a description of the FPS 14 and its integration with the fuel cell assembly 12 and the coolant system 16. A supply of carbon-based fuel 42, as for instance gasoline, natural gas or other similar hydrocarbons, is delivered by fuel pump 43 via heat exchangers 44 and 45 where it receives heat, and line 46, to a hydrodesulfurizer (HDS) 47 where sulfur is removed from the fuel. The HDS 47 may be optional if desulfurized fuel is used. The desulfurized fuel is then delivered via line 48 to an inlet region of a reformer 50, which may be an autothermal reformer (ATR), a catalytic partial oxidizer (CPOX), a catalytic steam reformer (CSR), or similar reactor for the reformation of the fuel stock. For the reformation process or reaction, the reformer 50 additionally typically requires sources of oxidant (air) and water or steam.

A feedwater pump 51 in the water line 16″ delivers the liquid water to various feeders to points of use in the FPS 14 as will be described. Water from line 16″ is delivered to the inlet region of the reformer 50 via feeder line 16a″ after receiving some heat passing through the cold side of an anode precooler 52 in line 16″.

Air for the reformer 50 is initially heated and humidified by passage thru the ERD 34, and is then delivered via lines 54 and 54′ by a driver, such as the gas compressor 53, through a heat exchanger 56 where it receives heat indirectly from the exhaust of the catalytic burner 40, and then to an inlet region of the reformer via line 57. The compressor 53 is preferably paired with and directly or indirectly driven by, a gas expander 55, the functions of which will be described in greater detail hereinafter. One or more water vapor injectors (sprays) 58 receive water from line 16″ via feeder line 16b″, and are positioned and operative to introduce water vapor to the air stream in line 57 prior to and/or after passage through the heat exchanger 56. To the extent the catalytic burner 40 may not be available as a source of heat, as during system start-up, a separate, limited-capacity start burner 59 is selectively and operatively connected (shown in broken line) to the supply of fuel 42 and the inlet air supplied by the ERD 34, such that the air may be warmed and supplied to line 57 for delivery to the reformer 50. Similarly, a limited-capacity electric heater may serve as the hot-side thermal source for the heat exchanger 45 during start up, or as needed.

The reformer 50 operates to react the air, water and carbon-based fuel in a well known manner to produce a stream of reformate containing a mixture of H₂, CO, CO₂, H₂O (and N₂). That reformate, after perhaps receiving a charge of water vapor in a vaporizer section 49, issues from the reformer 50 via line 60 and passes through the hot side of a heat exchanger 61 and to the inlet region of a water gas shift (WGS) membrane reactor 62. The WGS membrane reactor 62 will be described in greater detail, but suffice it to say at this point that the WGS reaction on the reformate creates a gaseous mixture rich in H₂ and in which much of the CO has been desirably converted to CO₂, then most of the H₂ is separated from the mixture via a separation membrane 64, and the remaining constituents of the reformate stream issue from the reactor 62 as an H₂-depleted retentate stream on line 66.

The retentate stream on line 66 continues to contain a small amount of H₂, and is supplied via expander 55 and line 66′, as one fuel source for the catalytic burner 40. Another fuel source for that burner 40 is provided by unspent H₂ in the anode exhaust stream of line 38. Oxidant (air) for the combustion reaction in burner 40 is supplied to the burner via blower 68. A heated stream of air and combustion products exhausted from burner 40 is extended on line 69 through the heat exchanger 56, to provide heat to the air being heated therein for supply on line 57 to the reformer 50. After exiting the heat exchanger 56, the burner exhaust stream 69 extends through the hot side of heat exchanger 44 and thence through the hot side 70A of a steam generating heat exchanger 70A&B and is connected to the cathode exhaust line 29 prior to being exhausted through the hot/warm side of ERD 34. A supplemental supply of heated water may be supplied as a spray to the stream 69 by vapor injector 71 connected between heat exchanger hot side 70A and the ERD 34, and receiving water from line 16″ via feeder line 16c″. This serves to cool the exhaust, if needed, and to add moisture to the stream that is recycled via the ERD 34.

System performance is enhanced by providing a portion of the H₂-containing reformate from the reformer 50, via line 60′ and through an ejector 72, to the HDS 47 for use in the desulfurization process. The ejector is driven by a pressurized stream of water on feeder line 16d″ connected to line 16 prior to precooler 52.

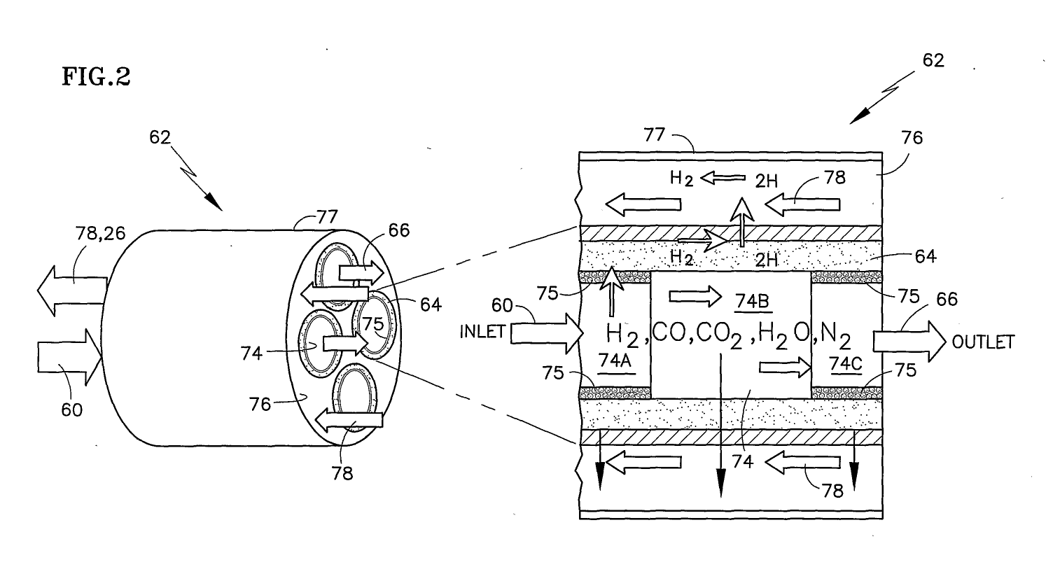

Attention is now turned to the WGS membrane reactor 62, which forms a principal component of the invention. Referring to FIG. 1 and additionally to FIG. 2, the WGS membrane reactor 62 comprises a WGS reaction region, generally designated 74, containing an appropriate water gas shift catalyst 75, such as a noble metal on an active support, or the like. The reaction region 74 may be comprised of an entry portion or section 74A, an exit portion or section 74C, and an intermediate portion or section 74B between the entry and exit portions or sections, for purposes to be described below in greater detail. These sections are depicted for ease of understanding the relative locations of shift catalyst 75 loaded in the WGS reaction region 74, and may vary in relative size, etc. Moreover, the overall size and length of the WGS reaction region 74 is a function of the catalyst activity and positioning, as well as the desired rate of H₂ separation. Gaseous reformate on line 61 from reformer 50 is supplied to the reaction region 74 where it undergoes the well-known WGS reaction to convert much of the entering CO to CO₂ and also further increase the H₂ available. This process includes the addition of water, which may occur in a final stage of reformer 50, as depicted in the present embodiment and represented by water vapor injector 73 connected to water feeder line 16e″ to inject water into the reformate in the vaporizer section 49. Alternatively, that injection of water vapor may occur in a separate vaporizer unit located between the reformer 50 and the WGS reactor 62, or it may occur in the WGS reactor 62 itself. System performance is additionally enhanced by recycling a portion of the retentate stream on exit line 66 to the vaporizer section 49 by connection to an ejector 63 which is driven by a pressurized stream of water supplied by, for example, feeder line 16c″. This returns some of the H₂ remaining in the retentate, via line 66″, for recycled reaction in the WGS membrane reactor 62.

To separate the H₂ from the reaction products in the reaction region 74 of the WGS membrane reactor 62, a membrane 64 of H₂-selective, permeable material forms an H₂-permeable boundary of the reaction region 74. The H₂-selective material is typically palladium or the like. Gaseous H₂ that diffuses through the H₂-permeable membrane 64 accumulates as a permeate in a permeate region 76, for transport to and use in, at least the anodes 18 of the fuel cell assembly 12.

FIG. 2 depicts in somewhat greater structural detail, an example of a WGS membrane reactor 62 in accordance with the invention. The WGS reaction region 74 is formed within and defined by a number of adjacent porous tubes depicted here as being formed entirely of the membrane 64, though it will be understood that the tubes may be a variety of materials and geometries, so long as the H₂ within the reaction region 74 is able to permeate through the membrane portion 64 thereof to reach the permeate region 76. An outer shell 77 loosely surrounds the several tubes comprising the individual WGS reaction regions 74, such that the space or region defined therebetween forms the permeate region 76 into which hydrogen atoms diffusing through the H₂-permeable membrane flow and accumulate. From the permeate region 76, the H₂ may be delivered via line 26 and the warm side of anode precooler 52, to the anodes 18.

An aspect of the invention is the reliance upon an energy-efficient, intermediate-pressure regime for operation of the fuel cell power plant 10. In that regard, it may be advantageous to provide some pressurization in the FPS 14 to increase the pressure differential across the membrane 64, yet also advantageous to limit the size and capacity of equipment necessary to provide and contain the resulting pressures. To that end, and in conjunction with the PEM fuel cell assembly 12 that typically operates near ambient pressure, the air on line 57 delivered to the reformer 50 is pressurized in the range of 1-10 bar, and is preferably about 6 bar. This is accomplished by the compressor 53. Some of the retentate exiting the WGS membrane reactor 62 on line 66 is fed to the expander 55, where its pressure is reduced and then used to partially fuel the catalytic burner 40. This expansion of the retentate at the expander 55 also serves to recover energy which may then be used to power a motor/generator 67 connected thereto, and/or to drive the compressor 53 which is placed on the same shaft 65 as the expander, thus resulting in efficient energy usage. Whereas the operating pressure in much of the FPS 14 is preferably at an intermediate pressure of about 6 bar, it will be understood that if operation at or near the ambient condition of 1 bar is alternatively preferred, the need for the pressure controlling equipment described above may be avoided.

At this juncture it is important to consider an important aspect of the invention, that being the use of a sweep gas flowing through permeate region 76 as not only facilitating transport of the H₂ to the anodes 18, but importantly also, as facilitating the shifting of the WGS reaction towards the products within the reaction region 74. This is accomplished by continued removal of the H₂ from the permeate region 76 so as to enable high H₂ partial pressure differentials across the membrane portion 64, which facilitates flow of H₂ across the membrane portion 64 to decrease the H₂ present in the reaction region 74, which in turn acts to shift the WGS reaction equilibrium in a direction favorable to the production of H₂.

Although the sweep gas might be inert gas, nitrogen, the H₂-lean, moisture-laden exhaust from the anodes 18, or other suitable fluids, including phase-change materials, the sweep gas, designated 78 in FIG. 2, is preferably steam in accordance with the preferred embodiment of the invention. The use of steam as the sweep gas 78 serves to efficiently integrate and utilize the thermal and coolant components existing in the fuel cell power plant 10 and increase the life of the fuel cell assembly 12, by extending the life of the polymer electrolyte membrane 22. The steam forming the sweep gas 78 is provided by heating water in a feeder line 16f″ that passes through the cool side 70B of steam generating heat exchanger 70A&B and is connected to a water/steam vapor injector 80. The heat is obtained from the burner exhaust gas flowing in the hot side 70A of the heat exchanger. An additional source of hot water supplied to vapor injector 80 is obtained by extending a water feeder line 16g″ through the cool side of heat exchanger 61 and thence to the injector 80. The heat is obtained from the reformate flowing in line 60 through the hot side of heat exchanger 61. In each instance, the water in line 16″ that enters feeder lines 16f″ and 16g″ would have been heated by heat exchange with the H₂ permeate in line 26 that passes through the hot side of anode precooler 52 prior to delivery to anodes 18. System efficiency is obtained by using these thermal sources (burner exhaust and anode precooler) to provide the steam for the sweep gas.

In accordance with yet another aspect of the preferred embodiment of the invention, the sweep gas 78 in FIG. 2 is caused to flow through the permeate region 76 in a direction that is counter to (countercurrent) the direction in which the reformate (represented by line and flow arrow 60) flows through the WGS reaction region 74 and exits as retentate (represented by line and flow arrow 66). In FIGS. 1 and 2, the flow of reformate is from left to right, and the flow of the sweep gas is right to left within the permeate region 76. Referring only to FIG. 1, the sweep gas is not separately identified with a reference numeral, but may be considered to enter the right side of permeate region 76 via the vapor injector 80 and then flow leftward, entraining the H₂ and becoming the permeate flow, or H₂-rich fuel stream, designated by line 26 flowing to the anodes 18. It has been found that use of a counter-flow arrangement increases the efficiency for a given volume of the membrane reactor 62.

Still further, it has been found that the catalyst 75, to the extent it exists in the middle of the WGS reaction region 74, here designated intermediate portion 74B, relative to longitudinal flow of reformate therethrough, is not utilized effectively in a counter flow configuration because the H₂ and CO fractions are too close to equilibrium to have appreciable affect on the rate of the WGS reaction. However, towards the entry and exit end(s) or portions 74A and 74C of the reaction region 74, as the hydrogen partial pressure decreases, the shift reaction is promoted towards the product side, such that having the catalyst at the end of the reactor enables complete conversion of CO. Accordingly, in the operational configuration where the sweep gas flows countercurrent to the reformate flow, the tubes of membrane material 64 that collectively define the WGS reaction region 74 are filed or otherwise loaded with catalyst 75 at or near the entry portion 74A and the exit portion 74C of the region/tubes, and the intermediate portion remains relatively vacant for use only for hydrogen separation. This loading is reflected in FIG. 1 by inclusion of the word “Shift” and the catalyst reference numeral “75” only in the entry and the exit sections of reactor 62. Depending upon catalyst activity, the relative flow of sweep gas 78 and reformate, and the extent of hydrogen removal, the loading of catalyst 75 might typically be concentrated in approximately the first 20% and the final 20% of the flow length of reactor 74, with little or no catalyst loading in the intermediate section. Such a catalyst loading profile would be appropriate for a 50 kW fuel cell based power plant fueled by gasoline, for ˜78% hydrogen recovery, and a 15 liter membrane reactor operating at ˜7 bars with a membrane permeance of 30 m³/m²-hr-atm^{0.5}, providing that the permeance of the membrane is independent of the gas composition. This configuration then affords a reduction in the cost and amount of equipment and material required, while preserving the efficiency of the system.

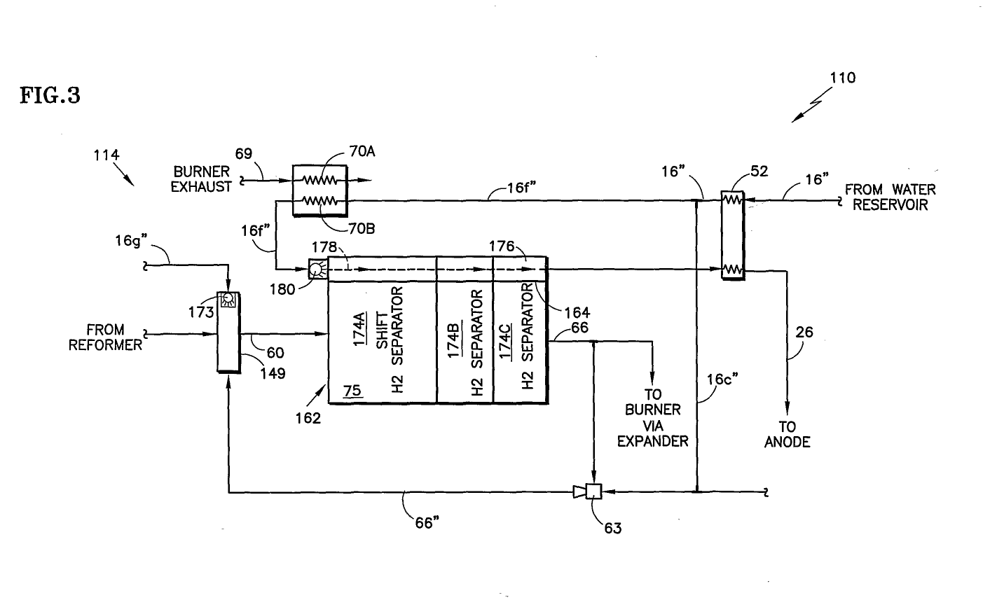

Referring to FIG. 3, there is depicted that portion of the FPS 114 of a fuel cell power plant 110 that depicts an alternate aspect of the invention. Because the components in the FIG. 3 embodiment are either the same or functionally similar to those in FIGS. 1 and 2, the same numbering convention has been maintained, however a “1” precedes those components that differ somewhat in positioning or structure, and additional description or comment is provided. The present embodiment differs mainly in that although the steam providing the sweep gas on line 16f″ is developed in the same way by heating in heat exchangers 52 and 70B and is injected into the permeate region 76 by a vapor injector 180, it will be noted that the injection occurs at the same end and direction of the WGS membrane reactor 162 as the introduction of the reformate on line 60. Thus, the steam sweep gas is directed to flow cocurrently with the reformate stream. In this configuration, it has been found that efficient usage of the catalyst 175 is optimized if it is loaded mostly in only a limited portion of the first half of the WGS reactor 174 (in the direction of reformate flow), because it has been found to provide nearly the same results as being loaded over the entire length. More specifically, the majority of catalyst loading should occur over about 20% of the first half of the WGS reactor 174, as represented by the catalyst reference numeral 175 and the word “Shift” appearing in entry portion 174A. While this configuration results in a reduction in the amount of WGS catalyst used, it is limited because it is not able to complete shift in the equilibrium due to accrued hydrogen in the sweep gas at the exit of the reactor. This has the effect, relative to the embodiments of FIGS. 1 and 2, of reducing the driving force for hydrogen removal for practical operating pressures.

Additionally in FIG. 3, it will be noted that the H₂ in retentate 66 that is recycled via the ejector 63 is conveyed via line 66″ to a vaporizer 149 that is depicted as free-standing, or separate, from a reformer or source of reformate, as was earlier mentioned.

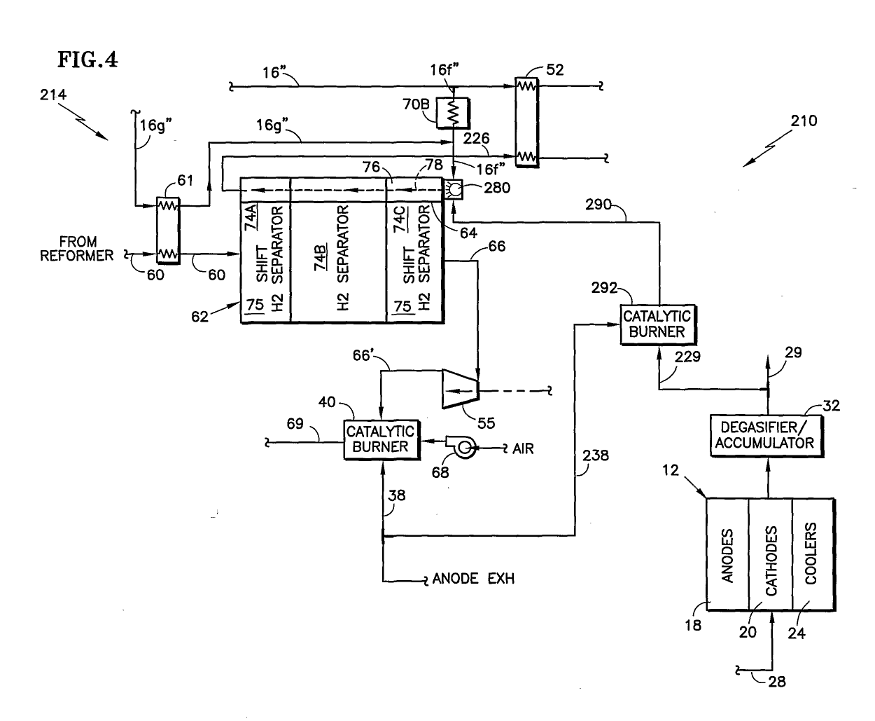

Referring to FIG. 4, there is depicted that portion of the FPS 214 of a fuel cell power plant 210 that depicts an alternate aspect of the invention with respect to the sweep gas 278. Because most of the components in the FIG. 4 embodiment are either the same or functionally similar to those in FIGS. 1 and 2, the same numbering convention has been maintained, however a “2” precedes those components that differ somewhat in positioning or structure, new components are numbered beginning with a “2” and followed by two digits in the 90's, and additional description or comment is provided. This embodiment differs in that the sweep gas 278 is not simply steam, but is an inert gas, such as nitrogen (N₂) in line 290, that is, or may be, conveniently accompanied by steam 16f″.

A second catalytic burner 292 receives H₂ and water from the anode exhaust via line 238, and an oxidant-depleted supply of N₂-rich air via line 229 from the exhaust of fuel cell cathode 20. The burner 292 and the supply of N₂-rich air are regulated carefully to provide a gaseous exhaust stream that is rich in N₂ and substantially devoid of O₂, and is connected via line 290 to a vapor injector 280. Also connected to the vapor injector 280 is the steam supply line 16f″, such that a measure of steam (H₂O) may be mixed with the N₂ to provide the resulting sweep gas 278. This particular arrangement for using N₂ as a significant portion of the sweep gas has the advantages, relative to steam alone, that the vaporizer and heat exchanger elements may be down-sized, and the use of steam is decreased. While this arrangement may have the disadvantage of slightly lowering the partial pressure of hydrogen supplied to the fuel cell stack assembly 12 (due to the presence of gaseous nitrogen in the fuel feed stream), it is a modest penalty.

Although the invention has been described and illustrated with respect to the exemplary embodiments thereof, it should be understood by those skilled in the art that the foregoing and various other changes, omissions and additions may be made without departing from the spirit and scope of the invention.

1. A fuel cell power plant system (10) comprising:
at least one fuel cell stack assembly (12) including an anode (18), a cathode (20), and a coolant channel (24);
a fuel processing system (14, 114, 214) for providing H₂ to the anode (18) and including a water gas shift membrane reactor (62, 162)) having a reaction region (74, 174) and a permeate region (76, 176) separated by a H₂ separation membrane (64, 164), the reaction region being connected to receive a supply stream of H₂-rich reformate (60) and a supply of water (16e″, 73, 173) for supporting a water gas shift reaction of the reformate to enhance the production of H₂ and to shift CO to CO₂, the produced H₂ being selectively separated from the reformate stream via the membrane to form a permeate (26, 126, 226) in the permeate region of the reactor, and the reformate stream issuing from the reactor as a retentate (66);
a sweep gas (78, 178, 278) connected (80, 180, 280) to flow through the permeate region of the water gas shift membrane reactor;
a source of heat (40, 70A/70B, 50, 62, 162); and
a water management system (16, 16′, 16″, 116″, 12, 34) operatively connected (30, 31, 32, 33) to the fuel cell assembly coolant channel (24) for conducting water from and to the fuel cell assembly, the water management system additionally being connected (70A/70B, 52, 229) to the source of heat for converting some water to steam, and the steam being operatively connected (80, 180, 280,) to provide at least a portion of the sweep gas (78, 178, 278).

2. The fuel cell power plant system of claim 1 wherein the reformate (60) flows through the reaction region of the water gas shift membrane reactor in a first flow direction; and the stream of sweep gas (78, 278) is connected to flow through the permeate region in a second flow direction substantially counter to said first flow direction.

3. The fuel cell power plant system of claim 2 wherein the reaction region of the water gas shift membrane reactor includes an entry portion (74A), an exit portion (74C), and an intermediate-portion (74B) between the entry and exit portions relative to said first flow direction of the reformate; and a water gas shift catalyst (75) is loaded substantially only in the entry and the exit portions of the water gas shift membrane reactor.

4. The fuel cell power plant system of claim 3 wherein the extent of the entry portion (74A) and the extent of the exit portion (74B) which each receive the loading of the catalyst (75) are each about 20% of the total extent of the reaction region of the water gas shift membrane reactor.

5. The fuel cell power plant system of claim 3 including pressure control means (53, 55) for regulating the operating pressure of at least the reformate flow stream through the water gas shift membrane reactor reaction region to be a moderate pressure in a range of about 1 to 10 bar.

6. The fuel cell power plant system of claim 5 wherein the pressure control means regulates the operating pressure of the reformate to be about 6 to 7 bar.

7. The fuel cell power plant system of claim 5 wherein said pressure control means comprises a compressor (53) for pressurizing air to within said range of moderate pressure for delivery to at least the water gas shift membrane reactor, an expander (55) connected to receive said retentate (66) from said water gas shift membrane reactor at a pressure substantially within said range of moderate pressure and expanding said retentate to reduce the pressure thereof and thereby release stored energy, and energy utilization means (65, 67) operatively connected to the expander and to the compressor for powering the compressor.

8. The fuel cell power plant system of claim 2 wherein said source of heat comprises a burner (40), said burner being operatively connected (66′) to receive said retentate stream as a fuel source.

9. The fuel cell power plant system of claim 1 wherein the reformate (60) flows through the reaction region of the water gas shift membrane reactor in a first flow direction; and the stream of sweep gas (178) is connected to flow through the permeate region in a second flow direction substantially the same as said first flow direction.

10. The fuel cell power plant system of claim 9 wherein the reaction region (174) of the water gas shift membrane reactor includes an entry portion (174A), an exit portion (174C), and an intermediate-portion (174B) between the entry and exit portions relative to said first flow direction of the reformate; and a water gas shift catalyst (75) is loaded substantially only in the entry portion (174B) of the water gas shift membrane reactor.

11. The fuel cell power plant system of claim 10 wherein the entry portion (174A) extends half the length of the reaction region of the water gas shift membrane reactor, and the extent of the entry portion that receives the water gas shift catalyst extends about 20% of the total extent of the reaction region of the water gas shift membrane reactor.

12. The fuel cell power plant system of claim 1 further including means (292, 228, 229) for providing a supply of inert gas (290), said inert gas being operatively connected (280) in combination with said steam to provide said sweep gas (278).

13. In a fuel processing system (14) for providing H₂ from a supply of H₂-rich reformate (60), a water gas shift membrane reactor (62, 162) having a reaction region (74, 174) and a permeate region (76, 176) separated by an H₂ separation membrane (64, 164), the reaction region containing a shift catalyst (75) and being connected to receive a stream of the H₂-rich reformate (60) flowing there through in a first flow direction and a supply of water (16e″, 73, 173) for supporting a water gas shift reaction to enhance the production of H₂ and to shift CO to CO₂, the produced H₂ being selectively separated from the reformate stream via the membrane to form a permeate (26, 126, 226) in the permeate region of the reactor, a stream of sweep gas (78, 178, 278) connected to flow through the permeate region in a particular second flow direction relative to the 1^{st} flow direction of the reformate, and wherein the catalyst in the reaction region is distributed therein as a function of said 1^{st} and 2^{nd} flow directions.

14. The fuel processing system of claim 13 wherein the reaction region (74) of the water gas shift membrane reactor includes an entry portion (74A), an exit portion (74C), and an intermediate portion (74B) between the entry and exit portions relative to said first flow direction of the reformate; the flow of the stream of sweep gas through the permeate region in the second flow direction is substantially counter to said first flow direction; and the water gas shift catalyst is loaded substantially only in the entry and the exit portions (74A and 74C) of the water gas shift membrane reactor.

15. The fuel processing system of claim 13 wherein the reaction region (174) of the water gas shift membrane reactor includes an entry portion (174A), an exit portion (174C), and an intermediate portion (174B) between the entry and exit portions relative to said first flow direction of the reformate; the flow of the stream of sweep gas through the permeate region in the second flow direction is substantially the same as said first flow direction; and the water gas shift catalyst is loaded substantially only in the entry portion (74A) of the water gas shift membrane reactor.
